(19) United States
(12) Patent Application Publication
(10) Pub. No.: US 2010/0031518 A1
(43) Pub. Date: Feb. 11, 2010

(54) HAND HELD POWER SAW APPARATUS AND METHOD

(76) Inventor: John A. Fedor, Edison, NJ (US)

Correspondence Address: Mr. Walter J. Teneza Jr., Suite 210, 100 Menlo Park, Edison, NJ, 08837, US

(21) Appl. No.: 12/189,343

(22) Filed: Aug. 11, 2008

(51) Int. Cl. B27B 3/12; B27B 5/29; B23P 19/04

(52) U.S. Cl. 30/392; 30/371; 30/517; 29/700

(57) ABSTRACT

An apparatus is provided comprising a saw blade, and a saw body portion of a power saw. A lower retaining device, which can hold an object so that the object can be cut by the saw blade, is attached to the saw body portion. The lower retaining device may be attached to the saw body portion so that the object holding device can pivot with respect to the saw body portion. The apparatus may be a reciprocating saw. The lower retaining device may be supplemented with an upper retaining device for holding an object tightly while cutting.

### FIELD OF THE INVENTION

This invention relates to improved methods and apparatus concerning hand held power saws.

### BACKGROUND OF THE INVENTION

There are various devices known in the prior art for reciprocating saws. In using a reciprocating saw, one hand presses on a standard trigger handle switch, and the other hand supports the reciprocating saw under a front just to the rear of a cutting blade. In order to use a typical prior art reciprocating saw to cut tree branches, a user would typically require some sort of support or brace, to support the material to be cut.

### SUMMARY OF THE INVENTION

One or more embodiments of the present invention provide an accessory attachment to a handheld power saw, such as a common reciprocating saw produced by many electric tool manufacturers. The accessory attachment may be attached with a worm gear hose clamp, or may be incorporated into a saw housing. The accessory attachment may be attached so that it can be easily removed.

In at least one embodiment of the present invention an apparatus is provided comprising a handheld power saw having a saw blade, and a lower retaining device attached to the handheld power saw. The lower retaining device may be attached so that an object can be placed on the lower retaining device and while the object is on the lower retaining device, the object can be cut by the saw blade. The lower retaining device may be attached to a body portion of the handheld power saw so that the lower retaining device can pivot with respect to the body portion. The handheld power saw may be a reciprocating saw. The lower retaining device may be biased in a direction so that when the object is placed on the lower retaining device, the lower retaining device automatically moves the object to cause the object to be cut by the saw blade. The lower retaining device may be biased by a spring.

The apparatus may further include an upper retaining device attached to the handheld power saw. The upper retaining device may be attached to the handheld power saw so that the object can be placed between the lower retaining device and the upper retaining device and while between the lower and upper retaining devices, the object can be cut by the saw blade. The lower retaining device may be biased in a first direction so that when the object is placed on the lower retaining device, the lower retaining device automatically moves the object to cause the object to be cut by the saw blade, and the upper retaining device may be biased in a second direction opposite the first direction so that the upper retaining device holds the object tight against the lower retaining device.

The lower retaining device may include a first member and a second member. The first member may be substantially perpendicular to the second member. The first member may be attached to a saw body portion of the handheld power saw so that the first member can pivot with respect to the saw body portion. A handle may be attached to the lower retaining device. The lower retaining device may be attached to a saw body portion of the handheld power saw so that the lower retaining device can pivot with respect to the saw body portion when the handle is moved in a first direction or a second direction. The lower retaining device may be configured with respect to the saw blade so that when the lower retaining device holds an object at a first position and when the handle is moved in the first direction, the object moves into contact with the saw blade. The lower retaining device may be configured with respect to the saw blade so that when the lower retaining device holds an object in the first position and when the handle is moved in the second direction, the lower retaining device moves the object away from contact with the saw blade.

The handheld power saw may include a saw body portion, wherein the saw body portion includes a first end and a second end, which is opposite the first end. A trigger is located nearer the first end than the second end. The trigger when actuated causes the saw blade to move in a cutting motion. The saw blade may be located nearer the second end of the saw body portion than the first end. The lower retaining device may be located nearer the second end of the saw body portion than the first end.

The lower retaining device may include a third member. The third member may be substantially perpendicular to the first member and connected to the first member and substantially parallel to the second member, and the handle may be connected to the third member. The lower retaining device may be configured with respect to the saw blade so that when the lower retaining device holds an object at a first position and when the handle is moved in a first direction, the object moves towards contact with the saw blade, so that the object can be cut by the saw blade. The lower retaining device may be configured with respect to the saw blade so that when the lower retaining device holds an object in the first position and when the handle is moved in the second direction, the lower retaining device moves the object away from contact with the saw blade, so that the object can not be cut by the saw blade.

One embodiment of the present invention provides a method including attaching a lower retaining device to a saw body portion of a hand held power saw, wherein the lower retaining device is attached to the saw body portion so that the lower retaining device can hold an object in a manner which allows the object to be cut by a saw blade of the hand held power saw. The lower retaining device may be configured as previously described and may be supplemented with an upper retaining device.

The lower retaining device may be attached to the saw body portion by a mounting device including a worm gear band.

One or more embodiments of the present invention add a combination handle at a location where a user's support hand (non-trigger hand) would be located. One or more embodiments of the present invention add a spring loaded scissor saw vise that holds branches, pvc pipe, steel pipe, angle iron or other materials against a saw blade to create a more square and subsequently faster cut and at the same time allow a user to firmly or loosely, depending on blade type, hold the material while cutting without another person or support device. In at least one embodiment, once the material is cut, the device would return to a rest position actuated or biased by one or more coil springs and/or a handle. In at least one embodiment, a rear arm member may act as a stop against the top of a saw body portion and prevent the handle from rotating any further thereby allowing the handle to pick up the front of the saw. To load material, the handle would be pushed forward and rotated under the blade to allow loading and another cut.

With larger branches or hard to cut larger materials, such as materials with three to five inch diameters or more, once the cut is started it is conceivable for one hand operation until near the end of the cut, as the spring tension can control feed pressure.

When continuously cutting the same materials, adjustable spring tension could be added to match cutting speeds of specific blades.

The device can be employed by anyone to cut branches at home, tradesmen on the jobsite or in a fabricating shop.

The combined saw and scissor saw vise can be simply suspended with a rope from above (common ladder or saw horse) in a vertical position while someone lubricates more difficult and lengthy cuts (steel pipe). The device principle can also operate in a weightless (space) environment.

### BRIEF DESCRIPTION OF THE DRAWINGS

FIG. 1 shows a right side view of a reciprocating saw of the prior art;

FIG. 2A shows a right side view of the reciprocating saw of FIG. 1 with a mounting device in accordance with an embodiment of the present invention shown attached to the reciprocating saw, and an upper retaining device in accordance with an embodiment of the present invention shown detached from the reciprocating saw;

FIG. 2B shows a right side view of the reciprocating saw of FIG. 1 along with the mounting device and the upper retaining device of FIG. 2A attached to the reciprocating saw, and along with a first spring attached to the upper retaining device and to the reciprocating saw;

FIG. 3A shows a right side view of the reciprocating saw of FIG. 1, the mounting device and the upper retaining device of FIG. 2 attached to the reciprocating saw, and a lower retaining device shown detached from the reciprocating saw;

FIG. 3B shows a right side view of the reciprocating saw of FIG. 1, the mounting device and the upper retaining device of FIG. 2 attached to the reciprocating saw, and the lower retaining device of FIG. 3A shown attached to the reciprocating saw, and along with a second spring attached to the lower retaining device and to the reciprocating saw;

FIG. 4 shows a top view of the reciprocating saw of FIG. 1 along with the mounting device, the upper retaining device, and the lower retaining device attached to the reciprocating saw;

FIG. 5A shows a front view of the reciprocating saw of FIG. 1 along with the mounting device, the upper retaining device and the lower retaining device attached to the reciprocating saw;

FIG. 5B shows a front view of the reciprocating saw of FIG. 1 along with the mounting device, the upper retaining device and the lower retaining device attached to the reciprocating saw, and along with a first spring attached to the upper retaining device and a second spring attached to the lower retaining device;

FIG. 6A shows a right side, top, front perspective view of an apparatus comprised of the reciprocating saw of FIG. 1 along with the mounting device, the upper and lower retaining devices and the first and second springs attached to the reciprocating saw, and with the apparatus shown in a first state;

FIG. 6B shows a right side, top, front perspective view of the apparatus of FIG. 6A and with the apparatus shown in a second state, and also shows a right side view of a tree log;

FIG. 7 shows a right side view of the apparatus of FIGS. 6A-B with the apparatus shown in the second state, and also shows a right side view of a tree log;

FIG. 8 shows a right side view of the apparatus of FIGS. 6A-B with the apparatus shown in a third state, and also shows a right side view of the tree log; and

FIG. 9 shows a right side view of the apparatus of FIGS. 6A-B with the apparatus shown hanging from a ladder.

### DETAILED DESCRIPTION OF THE DRAWINGS

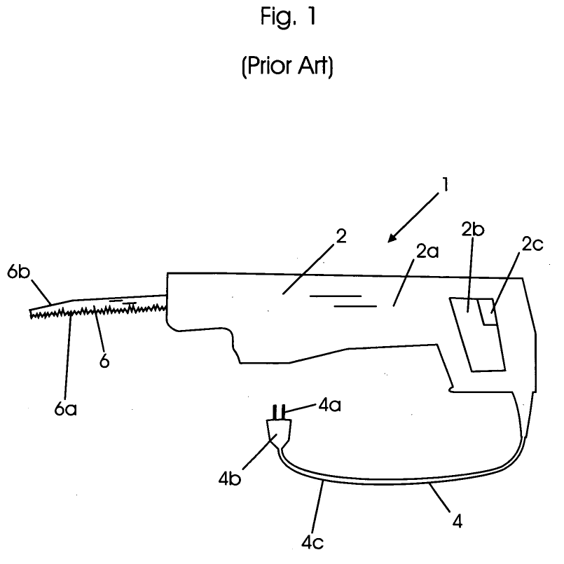

FIG. 1 shows a right side view of a reciprocating saw 1 of the prior art. The reciprocating saw 1 includes a body portion 2, a cord device 4, and a blade 6. The body portion 2, the cord device 4, and the blade 6 may be parts of a typical reciprocating saw as known in the prior art. The body portion 2 may include a main portion 2a and a trigger opening 2b. A trigger button 2c may be located in the trigger opening 2b. The trigger button 2c when squeezed may cause the blade 6 to oscillate back in forth in order to cut a material as known in the art. The blade 6 may include a side 6a having teeth, and a side 8b which is smooth. The cord device 4 may include portions 4a, 4b, and 4c. The portion 4a may have two or three prongs for plugging into an electrical outlet as known in the art. In an alternative embodiment of the invention, the cord device 4 may be eliminated and the saw 1 may be or may be replaced by a cordless device.

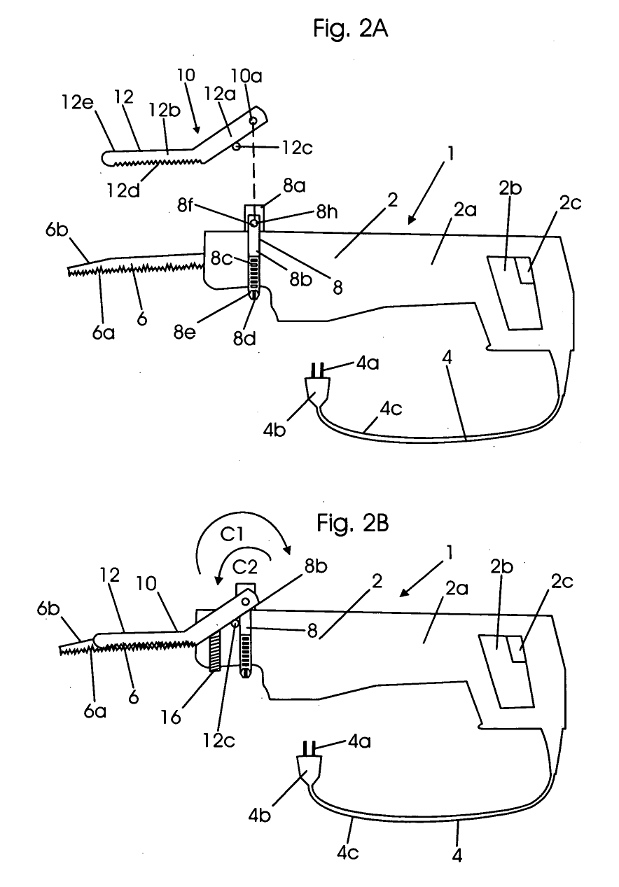

FIG. 2A shows a right side view of the reciprocating saw 1 with a mounting device 8 in accordance with an embodiment of the present invention shown attached to the reciprocating saw 1, and an upper retaining device 10 in accordance with an embodiment of the present invention shown detached from the reciprocating saw 1. FIG. 2B shows a right side view of the reciprocating saw 1 of FIG. 1 along with the mounting device 8 and the upper retaining device 10 of FIG. 2A attached to the reciprocating saw 1 and along with a first spring 16 attached to the upper retaining device 10 and to the reciprocating saw 1.

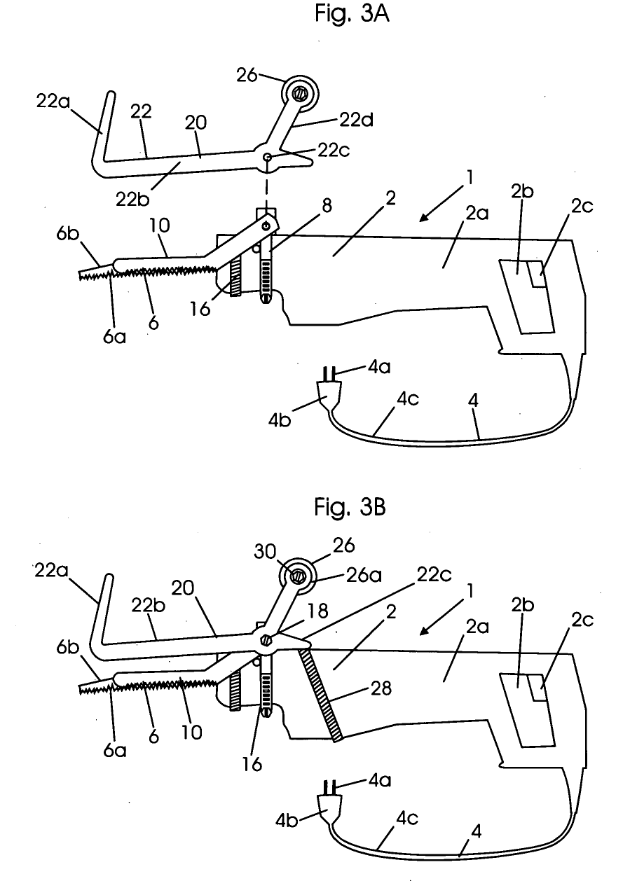

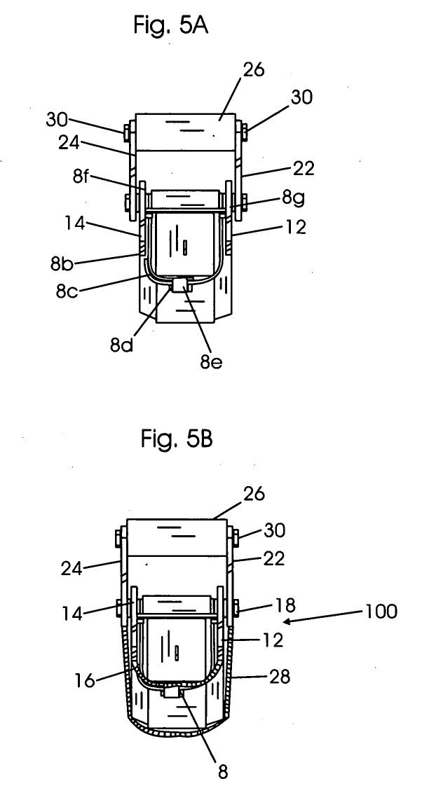

As shown by FIGS. 2A-2B and FIG. 5A, the mounting device 8 includes may be comprised of a block 8a and a clamping device which may include a first band 8b and a second band 8c. The mounting device 8 may also include a screw, bolt, and/or nut 8d, and a clamping piece 8e. The band 8b may have an opening 8f and the band 8c may have a opening 8g which aligns with the opening 8f. A bolt or screw, such as bolt or screw 18 as shown in FIG. 3B (but not shown in FIG. 2B) can be inserted through the openings 8f and 8g, through a bore or opening 8h in block 8a, and through an opening 10a in the upper retaining device 10, in order to attach the upper retaining device 10, the block 8a, and the bands 8b and 8c to the reciprocating saw 1 as shown by FIG. 3B.

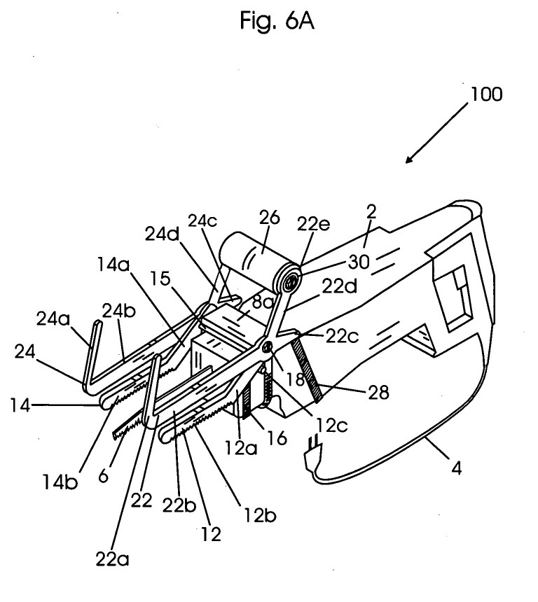

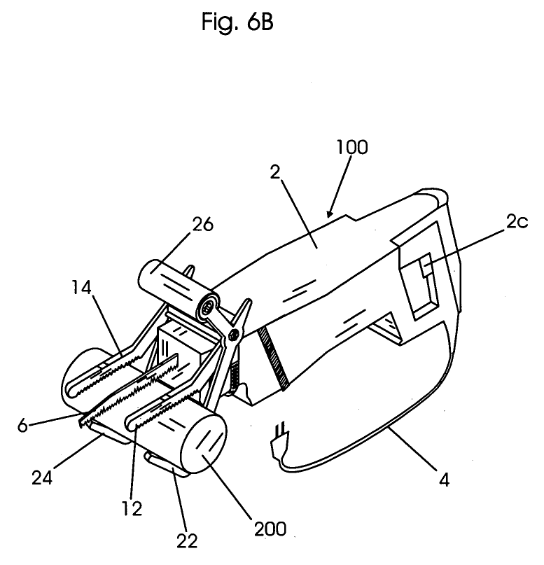

As shown in FIG. 6A, the upper retaining device 10 includes right side leg or portion 12 and left side leg or portion 14. The right side leg or portion 12 includes members 12a and 12b, which may be at an angle of approximately one hundred and fifty degrees with respect to one another. Similarly, the left side leg or portion may include members 14a and 14b, which may be at an angle of approximately one hundred and fifty degrees with respect to one another. The members 12b and 14b have sides 12d and 14d which are shown as having teeth for cutting wood or softer materials. Instead of teeth, the sides 12d and 14d may have vinyl sleeves for gripping smooth surfaced objects such as PVC (polyvinyl chloride) pipe, steel, aluminum or copper. The members 12b and 14b also have sides 12e and 14e, respectively, which are typically smooth. The right side leg portion 12 is connected to the left side leg portion 14 by a member 15 shown in FIG. 6A.

The right side leg or portion 12 includes a stop member 12c, as shown in FIGS. 2A and 6A, and the left side leg or portion 14 includes a similar stop member, not shown. The stop member 12c and similar stop member for leg or portion 14 prevents the upper retaining device from rotating further counterclockwise than the position shown in FIG. 2B, by contacting portion 8b of mounting device 8. The upper retaining device 10 is thus positioned into the rest state of FIG. 2B and 6A by the spring 16 which biases the upper retaining device 10 in a counterclockwise C2 direction and by stop 12c which prevents the upper retaining device 10 from rotating further counterclockwise than the rest position of FIG. 2B.

FIG. 3A shows a right side view of the reciprocating saw 1, the mounting device 8 and the upper retaining device 10 attached to the reciprocating saw 1, and a lower retaining device 20 shown detached from the reciprocating saw 1. FIG. 3B shows a right side view of the reciprocating saw 1, the mounting device 8 and the upper retaining device 10 attached to the reciprocating saw 1 and the lower retaining device 20 shown attached to the reciprocating saw 1, and along with a second spring 28 attached to the lower retaining device 20 and to the reciprocating saw 1.

The lower retaining device 20 includes right side leg or portion 22 and left side leg or portion 24. The right side leg or portion 22 includes members 22a and 22b, which may be at an angle of approximately ninety degrees with respect to one another. Similarly, the left side leg or portion may include members 24a and 24b, which may be at an angle of approximately ninety degrees with respect to one another. The right side leg portion 22 is connected to the left side leg portion 24 by a bolt or pivot pin 18, and also by a bolt 30, as shown in FIG. 6A. The right side leg or portion 22 also includes member 22c and member 22d. The member 22d has an opening 22e through which bolt 30 can be inserted. The left side leg or portion 24 also includes member 24c and member 24d. The member 24d has an opening (not shown) through which bolt 30 can be inserted.

The lower retaining device 20 includes a handle 26 having a bore opening 26a which is aligned with the openings 22e of the right leg portion 22 and the corresponding opening, not shown, of the left leg portion 24. The bolt 30 can be inserted through the opening 22e, through the bore opening 26a and through the corresponding opening of the left leg portion 24, in order to attached the handle 26 to the rest of the lower retaining device 20. The bolt 30 may include a nut, not shown. The spring 28 may attach the portions or members 22c and 24c of the right and left leg portions 22 and 24, respectively, to the body portion 2 of the reciprocating saw 1. The spring 28 biases the upper retaining device 20 into the state shown in FIG. 3B absent any external force.

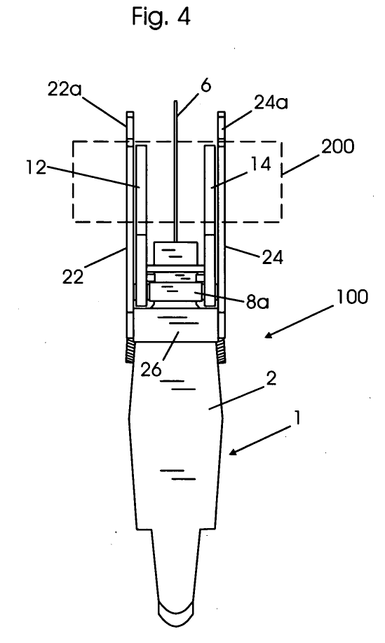

FIG. 4 shows a top view of a completed apparatus 100 comprised of the reciprocating saw 1 along with the mounting device 8, the upper retaining device 10 and the lower retaining device 20 attached to the reciprocating saw 1. FIG. 4 also shows a tree log 200 in dashed lines.

FIG. 5A shows a front view of the reciprocating saw 1 of FIG. 1 along with the mounting device 8, the upper retaining device 10 and the lower retaining device 20 attached to the reciprocating saw 1, but without the springs 16 and 28 which are shown in FIG. 5B. FIG. 5B shows a front view of the completed apparatus 100 in accordance with an embodiment of the present invention with the springs 16 and 28.

FIG. 6A shows a right side, top, front perspective view of the apparatus 100 with the apparatus 100 shown in a first state. FIG. 6B shows a right side, top, front perspective view of the apparatus 100 of FIG. 6A and with the apparatus shown in a second state, and also shows a right side view of the tree log 200 inserted into the apparatus 100 as shown. In FIG. 6B, the tree log 200 is held underneath by members 24 and 22 of the lower retaining device 20 and is held on top by the members 14 and 12 of the upper retaining device 10. The tree log 200 is also held on top by the blade 6.

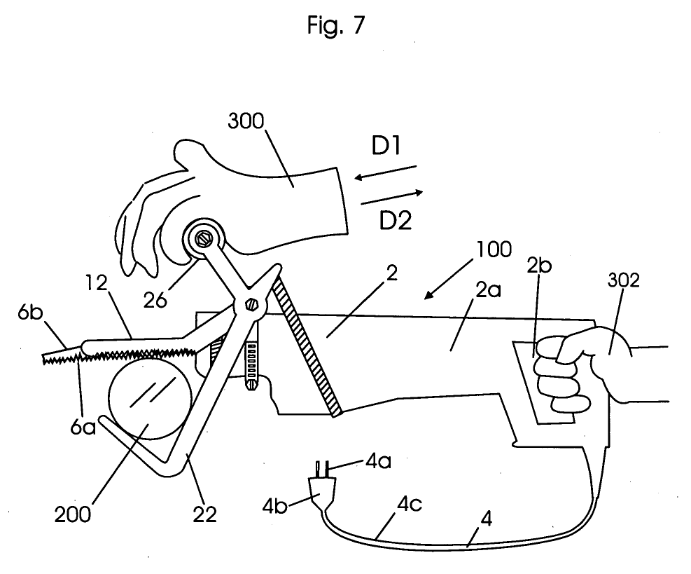

FIG. 7 shows a right side view of the apparatus 100 of FIGS. 6A-B with the apparatus 100 shown in the second state, and also shows a right side view of the tree log 200. As shown in FIG. 7, the apparatus 100 can be placed into the second state of FIG. 6B, by pushing on the handle 26 in the direction D1 with a hand 300 of a person, while the other hand 302 of the person holds onto the apparatus 100 as shown in FIG. 7. The log 200 can then be inserted between the members 12 and 22 and between the members 14 and 24 so that the log 200 lies as shown in FIG. 6B.

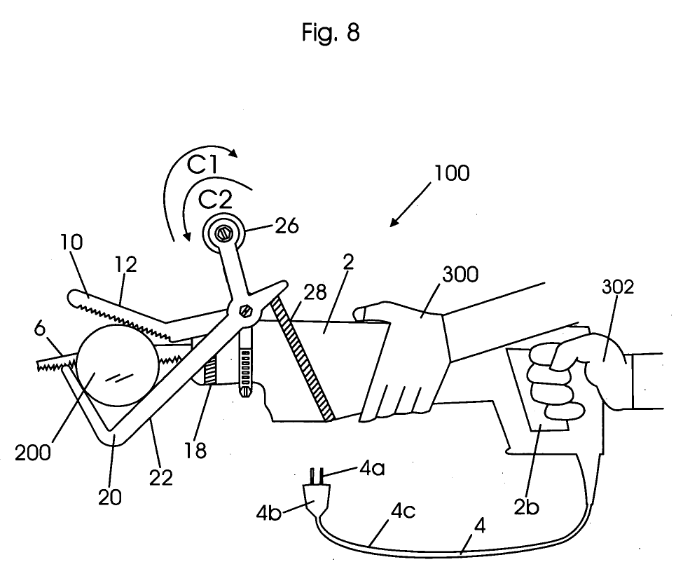

FIG. 8 shows a right side view of the apparatus 100 with the apparatus 100 shown in a third state, and also shows a right side view of the tree log 200. In FIG. 8, the person is now gripping the body portion 2 of the saw 1 with hand 300, i.e. the hand 300 no longer needs to hold the handle 26. This gives the person a more stable and safer grip on the saw 1 when the saw 1 is powered on. With the hands 300 and 302 in the position of FIG. 8, the saw 1 can be powered on with trigger 2c or with another button not shown. Because the lower retaining device 20 is biased upwards or clockwise C1 by spring 28, the lower retaining device 20 (legs 22 and 24) will push the log 200 upwards, and clockwise, into and through the moving blade 6, as the blade 6 cuts the log 200. At the same time, the upper retaining device 10 is biased downwards or counterclockwise C2, which causes the upper retaining device 10 (legs 12 and 14) to press down on the log 200 to keep the log 200 steady as it is cut by the blade 6.

The apparatus 100 of the present invention allows a log 200 to be cut without the aid of another device to hold the log 200 steady while cutting with the blade 6.

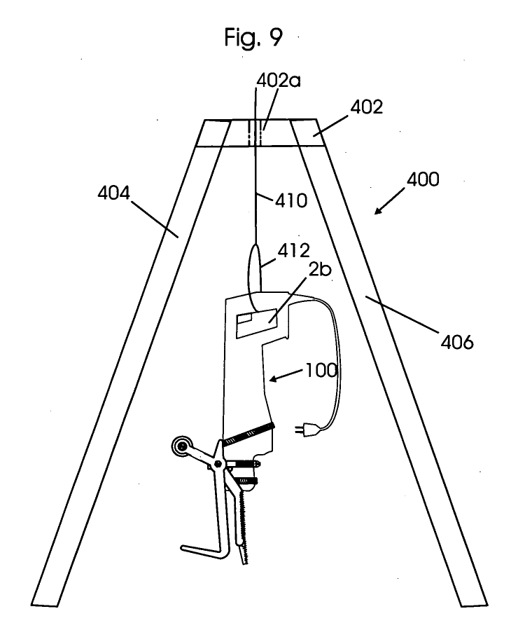

FIG. 9 shows a right side view of the apparatus 100 of FIGS. 6A-B with the apparatus 100 shown hanging from a saw horse or ladder 400. The saw horse 400 may include a horizontal member 402 fixed at an angle to members 404 and 406. The apparatus 100 may be suspended by a cord 410 which is inserted and/or attached at location 402a to the member 402 and to the saw horse 400. The cord 410 has a loop 412. The loop 412 goes through the trigger opening 2b.

In at least one embodiment, once the material, such as log 200, is cut, the device or apparatus 100 would return to a rest position shown in FIG. 3B or 6A, as a result of bias of lower retaining device 20 (legs 22 and 24) by one or more coil springs, such as coil spring 28.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a hand held power saw having a saw blade;
a lower retaining device attached to the hand held power saw; and
an upper retaining device attached to the handheld power saw;
wherein the lower retaining device is attached so that an object can be placed on the lower retaining device and while the object is on the lower retaining device, the object can be cut by the saw blade;
wherein the upper retaining device is attached to the handheld power saw so that the object can be placed between the lower retaining device and the upper retaining device and while between the lower and upper retaining devices, the object can be cut by the saw blade;
wherein the lower retaining device is biased in a first direction so that when the object is placed on the lower retaining device, the lower retaining device automatically moves the object to cause the object to be cut by the saw blade; and
the upper retaining device is biased in a second direction opposite the first direction so that the upper retaining device holds the object tight against the lower retaining device.

2. The apparatus of claim 1 wherein
the lower retaining device is attached to a body portion of the handheld power saw so that the lower retaining device can pivot with respect to the body portion.

3. The apparatus of claim 1 wherein
the handheld power saw is a reciprocating saw.

4. The apparatus of claim 1 wherein
the upper retaining device is attached to the hand held power saw through a pivot pin so that the upper retaining device can pivot about the pivot pin and with respect to the hand held power saw; and
the lower retaining device is attached to the hand held power saw through the pivot pin so that the lower retaining device can pivot about the pivot pin and with respect to the hand held power saw.

5. The apparatus of claim 1 wherein
the lower retaining device is biased by a spring.

6. The apparatus of claim 1 wherein
the upper retaining device is biased by a first spring.

7. The apparatus of claim 6 wherein
the lower retaining device is biased by a second spring.

8. The apparatus of claim 1 wherein
the lower retaining device includes a first member and a second member;
wherein the first member is substantially perpendicular to the second member; and
wherein the first member is attached to a saw body portion of the handheld power saw so that the first member can pivot with respect to the saw body portion.

9. The apparatus of claim 1 further comprising
a handle attached to the lower retaining device; and
wherein the lower retaining device is attached to a saw body portion of the handheld power saw so that the lower retaining device can pivot with respect to the saw body portion when the handle is moved in the first direction or the second direction
wherein the lower retaining device is configured with respect to the saw blade so that when the lower retaining device holds an object at a first position and when the handle is moved in the first direction, the object moves into contact with the saw blade;
and wherein the lower retaining device is configured with respect to the saw blade so that when the lower retaining device holds an object in the first position and when the handle is moved in the second direction, the lower retaining device moves the object away from contact with the saw blade.

10. The apparatus of claim 1
wherein the hand held power saw includes a saw body portion; and
wherein the saw body portion includes a first end and a second end, which is opposite the first end;
wherein a trigger is located nearer the first end than the second end;
wherein the trigger when actuated causes the saw blade to move in a cutting motion;
wherein the saw blade is located nearer the second end of the saw body portion than the first end;
and wherein the lower retaining device is located nearer the second end of the saw body portion than the first end.

11. The apparatus of claim 8 further comprising
a handle;
and wherein the lower retaining device includes a third member;
wherein the third member is substantially perpendicular to the first member and connected to the first member and substantially parallel to the second member, and wherein the handle is connected to the third member;
wherein the lower retaining device is attached to the saw body portion so that the lower retaining device can pivot with respect to the saw body portion when the handle is moved in the first direction or the second direction;
wherein the lower retaining device is configured with respect to the saw blade so that when the lower retaining device holds an object at a first position and when the handle is moved in the first direction, the object moves towards contact with the saw blade, so that the object can be cut by the saw blade;
and wherein the lower retaining device is configured with respect to the saw blade so that when the lower retaining device holds an object in the first position and when the handle is moved in the second direction, the lower retaining device moves the object away from contact with the saw blade, so that the object can not be cut by the saw blade.

12. The apparatus of claim 1 wherein
the upper retaining device is comprised of a first member and a second member, wherein the first member is attached at one end to the hand held power saw by a pivot pin and at its other end to the second member; and
wherein the first member and the second member are substantially straight elongated members; and
wherein the first member is at an angle of approximately one hundred and fifty degrees with respect to the second member.

13. A method comprising:
attaching a lower retaining device to a handheld power saw having a saw blade, so that an object can be placed on the lower retaining device and while the object is on the lower retaining device, the object can be cut by the saw blade; and
attaching an upper retaining device to the handheld power saw;
wherein the upper retaining device is attached to the handheld power saw so that the object can be placed between the lower retaining device and the upper retaining device and while between the lower and upper retaining devices, the object can be cut by the saw blade,
wherein the lower retaining device is biased in a first direction so that when the object is placed on the lower retaining device, the lower retaining device automatically moves the object to cause the object to be cut by the saw blade; and
the upper retaining device is biased in a second direction opposite the first direction so that the upper retaining device holds the object tight against the lower retaining device.

14. The method of claim 13 wherein
the lower retaining device is attached to a body portion of the handheld power saw so that the lower retaining device can pivot with respect to the body portion.

15. The method of claim 13 wherein
the handheld power saw is a reciprocating saw.

16. The method of claim 13 wherein
the upper retaining device is attached to the hand held power saw through a pivot pin so that the upper retaining device can pivot about the pivot pin and with respect to the hand held power saw; and
the lower retaining device is attached to the hand held power saw through the pivot pin so that the lower retaining device can pivot about the pivot pin and with respect to the hand held power saw.

17. The method of claim 13 wherein
the lower retaining device is biased by a spring.

18. The method of claim 13 further wherein
the upper retaining device is biased by a first spring.

19. The method of claim 18 wherein
the lower retaining device is biased by a second spring.

20. The method of claim 13 wherein
the lower retaining device includes a first member and a second member;
wherein the first member is substantially perpendicular to the second member; and
wherein the first member is attached to a saw body portion of the handheld power saw so that the first member can pivot with respect to the saw body portion.

21. The method of claim 13 further comprising
attaching a handle to the lower retaining device; and
wherein the lower retaining device is attached to a saw body portion of the handheld power saw so that the lower retaining device can pivot with respect to the saw body portion when the handle is moved in the first direction or the second direction;
wherein the lower retaining device is configured with respect to the saw blade so that when the lower retaining device holds an object at a first position and when the handle is moved in the first direction, the object moves into contact with the saw blade;
and wherein the lower retaining device is configured with respect to the saw blade so that when the lower retaining device holds an object in the first position and when the handle is moved in the second direction, the lower retaining device moves the object away from contact with the saw blade.

22. The method of claim 13
wherein the handheld power saw includes a saw body portion; and
wherein the saw body portion includes a first end and a second end, which is opposite the first end;
wherein a trigger is located nearer the first end than the second end;
wherein the trigger when actuated causes the saw blade to move in a cutting motion;
wherein the saw blade is located nearer the second end of the saw body portion than the first end;
and wherein the lower retaining device is located nearer the second end of the saw body portion than the first end.

23. The method of claim 20 wherein
the lower retaining device includes a third member;
wherein the third member is substantially perpendicular to the first member and connected to the first member and substantially parallel to the second member, and wherein a handle is connected to the third member;
wherein the lower retaining device is attached to the saw body portion so that the lower retaining device can pivot with respect to the saw body portion when the handle is moved in the first direction or the second direction;
wherein the lower retaining device is configured with respect to the saw blade so that when the lower retaining device holds an object at a first position and when the handle is moved in the first direction, the object moves towards contact with the saw blade, so that the object can be cut by the saw blade;
and wherein the lower retaining device is configured with respect to the saw blade so that when the lower retaining device holds an object in the first position and when the handle is moved in the second direction, the lower retaining device moves the object away from contact with the saw blade, so that the object can not be cut by the saw blade.

24. The method of claim 13 wherein
the upper retaining device is comprised of a first member and a second member, wherein the first member is attached at one end to the hand held power saw by a pivot pin and at its other end to the second member; and
wherein the first member and the second member are substantially straight elongated members; and
wherein the first member is at an angle of approximately one hundred and fifty degrees with respect to the second member.
